(19) United States
(12) Patent Application Publication
(10) Pub. No.: US 2020/0034581 A1
(43) Pub. Date: Jan. 30, 2020

(54) METHOD FOR CONTROLLING CARD READER

(71) Applicant: NIDEC SANKYO CORPORATION, NAGANO (JP)

(72) Inventors: Yohei SHIMIZU, NAGANO (JP); Shinya MIYAZAWA, NAGANO (JP); Kazuto SAEKI, NAGANO (JP)

(73) Assignee: NIDEC SANKYO CORPORATION, NAGANO (JP)

(21) Appl. No.: 16/337,404

(22) PCT Filed: Sep. 6, 2017
(86) PCT No.: PCT/JP2017/032155

§ 371 Date: Mar. 28, 2019

(30) Foreign Application Priority Data
Sep. 29, 2016 (JP) 2016-191608

(51) Int. Cl. G06K 7/08

(52) U.S. Cl. CPC G06K 7/087

(57) ABSTRACT

A card reader performs a reading operation of reading magnetic data by scanning the magnetic data in a first direction and a writing operation of writing the magnetic data by scanning the magnetic data in a second direction. Prior to these reading operation and writing operation, a head moving mechanism performs a preparatory operation of moving a magnetic head positioned in a head retracted position to a head contact position and a preliminary operation of moving the magnetic head slightly (e.g., about 1 mm) in the same direction as a scanning direction when the reading operation and the writing operation are performed. By performing the preliminary operation, even if a backlash caused by wearing due to use, gaps present for reasons of design, or the like increases and an unloaded area increases, a phenomenon that the head moving mechanism 8 operates unloaded during the preliminary operation can be eliminated.

### TECHNICAL FIELD

The present invention relates to a method for controlling a card reader that moves a magnetic head for scanning to read magnetic data recorded on a card and to write magnetic data on the card.

### BACKGROUND ART

Card readers in which a magnetic head is moved for scanning a magnetic stripe formed on a card to read or write magnetic data are used. Patent Literature 1 discloses this type of card reader. The card reader described in Patent Literature 1 conveys a substantially rectangular card in a transverse direction thereof and takes the card into the card reader, and scans the card with a magnetic head in a direction orthogonal to a direction in which card is conveyed to read and write magnetic data. A head moving mechanism that moves the magnetic head for scanning includes a carriage in which the magnetic head is mounted, a guide shaft that guides the carriage, a lead screw to which rotation of a motor is transmitted, a female screw member fixed to the carriage and engages the lead screw, a rotation stopper shaft that restricts rotation of the carriage, etc.

### CITATION LIST

### Patent Literature

Patent Literature 1: Japanese Unexamined Patent Application Publication No. 2013-164675

### SUMMARY

### Technical Problems

In the head moving mechanism of the card reader, there may be a gap for reasons of design between mechanical parts. Also, when the card reader is worn by use, the gap between the parts is widen and a backlash becomes larger. For example, a bearing member that supports a lead screw wears and a backlash becomes larger. If there is a gap between mechanical parts, when the head moving mechanism is to be driven, the head moving mechanism is driven with no load in a range of the gap. An increase in a backlash due to wearing or the like means an increase in an unloaded area. If the head moving mechanism operates unloaded, a moving speed of the magnetic head by the head moving mechanism is unstable.

In related art reading operation and writing operation by a magnetic head, control is performed such that the moving speed of the magnetic head reaches the target speed after driving is started, and then, while moving the magnetic head at the target speed along the magnetic stripe, the magnetic data is read or written. However, if the backlash becomes larger due to wearing, etc. as described above, an unloaded area increases, and a change in speed caused by a head movement unloaded after driving is started becomes larger. Therefore, there is a possibility that the moving speed of the magnetic head cannot reach the target speed until the magnetic head reaches a data recording area of the magnetic stripe. In a state in which the magnetic head is not moving at the target speed, the magnetic data cannot be read or written normally. Therefore, reading accuracy and writing accuracy may be lowered.

Even if the unloaded area becomes larger, a phenomenon that the magnetic head cannot reach the target speed before the start of reading or writing of the magnetic data does not occur if a distance (approach distance) from a position in which driving of the magnetic head is started to the data recording area of the magnetic stripe when the reading operation and the writing operation are to be performed can be increased. However, when the approach distance is increased, a scanning space of the magnetic head needs to be increased. Therefore, the size of the card reader increases in a head scanning direction. This configuration is not advantageous for downsizing of the card reader.

In view of the above problems, an object of the present invention is to provide a method for controlling a card reader that can inhibit lowering reading accuracy and writing accuracy caused by an increase in a gap between parts due to wearing or the like, and is advantageous for downsizing of the card reader.

### Solutions to Problems

To solve the problem described above, the present invention is a method for controlling a card reader that performs at least one of processings of reading magnetic data recorded on a card and writing magnetic data on the card by scanning with a magnetic head, the method including a preliminary operation step of moving the magnetic head by a predetermined amount in a scanning direction in performing the processing is performed prior to a main operation step of performing the processing by scanning with the magnetic head.

In the present invention, when performing at least one of operations of reading and writing by moving the magnetic head for scanning, prior to the operation, the preliminary operation of moving the magnetic head by a predetermined amount in the same direction as the scanning direction for the operation is performed. With this configuration, a phenomenon that the head moving mechanism operates unloaded during the preliminary operation can be eliminated even if the unloaded area increases due to wearing or the like. Therefore, a reading operation or a writing operation can be started under normal driving load. Therefore, there is little possibility that the moving speed of the magnetic head does not reach the target speed before the magnetic head reaches the recording position of the magnetic data due to an increase in the unloaded area. Therefore, lowering in reading accuracy and writing accuracy caused by an increase in gaps between parts can be inhibited. Further, since it is not necessary to increase the scanning space of the magnetic head to cause the moving speed of the magnetic head to reach the target speed, this configuration is advantageous for downsizing of the card reader in the head scanning direction.

The present invention is applicable to a configuration in which a taking-in step of conveying the substantially rectangular card in a transverse direction of the card and positioning the card in a predetermined position in which the processing is to be performed by the magnetic head is performed; and the scanning direction of the magnetic head is a direction orthogonal to a conveyance direction of the card. The substantially rectangular card includes a magnetic stripe extending in the longitudinal direction. Therefore, when the card is conveyed in the transverse direction, the head scanning direction matches a width direction of the card reader. Thus, it is necessary to increase the scanning space in the card reader in the width direction in order to increase the approach distance, which may upsize the card reader in the width direction. In the present invention, however, the target speed can be reached with a short approach distance by performing the preliminary operation, and it is not necessary to increase the scanning space in the card reader in the width direction. Therefore, this configuration is advantageous for downsizing of the card reader in the width direction thereof.

In the present invention, it is desirable that, in the main operation step, prior to a first scanning operation of moving the magnetic head for scanning in a first direction, the preliminary operation step of moving the magnetic head by a predetermined amount in the first direction is performed; and in the main operation step, prior to a second scanning operation of moving the magnetic head for scanning in a second direction opposite to the first direction, the preliminary operation step of moving the magnetic head by a predetermined amount in the second direction is performed. With this configuration, in a card reader in which the magnetic head is moved for scanning in the first direction and the second direction to perform predetermined processing, occurrence of an error in both of these operations can be inhibited. For example, when magnetic data is read during the first scanning operation and magnetic data is written in the second scanning operation, lowering in reading accuracy and writing accuracy can be inhibited. Since it is not necessary to increase the approach distance in the first direction and in the second direction, this configuration is advantageous for downsizing of the card reader in the head scanning direction.

In the present invention, it is desirable that the magnetic head is movable to a head retracted position in which the magnetic head does not come into contact with the card and a head contact position in which the magnetic head comes into contact with the card; a preparatory step of moving the magnetic head from the head retracted position to the head contact position is performed before the preliminary operation step is started; and the preliminary operation step and the main operation step are performed with the magnetic head moved to the head contact position. With this configuration, when the reading operation and the writing operation are not performed, conveyance of the card is not hindered by the magnetic head.

In the present invention, it is desirable that, in the preliminary operation step, a motor that moves the magnetic head is rotated at a constant speed. With this configuration, there is little possibility that the moving speed of the magnetic head changes significantly in the preliminary operation step.

### Effect of the Invention

According to the present invention, even if the unloaded area increases due to wearing or the like, a phenomenon that the magnetic head operates unloaded during the preliminary operation can be eliminated. Therefore, a reading operation or a writing operation can be started under normal driving load. Therefore, there is little possibility that the moving speed of the magnetic head does not reach the target speed before the magnetic head reaches the recording position of the magnetic data due to an increase in the unloaded area. Therefore, lowering in reading accuracy and writing accuracy caused by an increase in gaps between parts can be inhibited. Further, since it is not necessary to increase the scanning space of the magnetic head to cause the moving speed of the magnetic head to reach the target speed, this configuration is advantageous for downsizing of the card reader in the head scanning direction.

### BRIEF DESCRIPTION OF THE DRAWINGS

FIG. 1 is a perspective view of a card reader according to an embodiment of the present invention.

FIG. 2 is an explanatory view illustrating an internal configuration of the card reader illustrated in FIG. 1 when viewed from a side.

FIG. 3 is a plan view of a card to be processed in the card reader illustrated in FIG. 1.

FIG. 4 is a plan view of a head moving mechanism.

FIG. 5 is a front view of the head moving mechanism.

FIG. 6 is a schematic block diagram illustrating a control system of the card reader.

FIG. 7 is a flowchart illustrating control of a magnetic head and the head moving mechanism.

### DESCRIPTION OF EMBODIMENTS

Below, embodiments of a method for controlling a card reader to which the present invention is applied will be described with reference to the drawings.

(Entire Configuration of Card Reader)

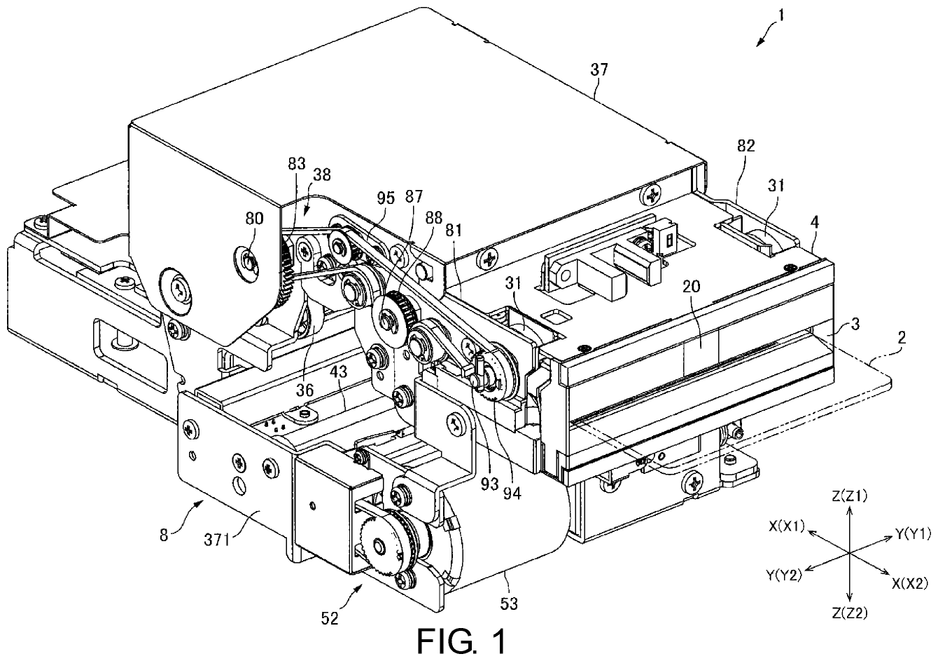

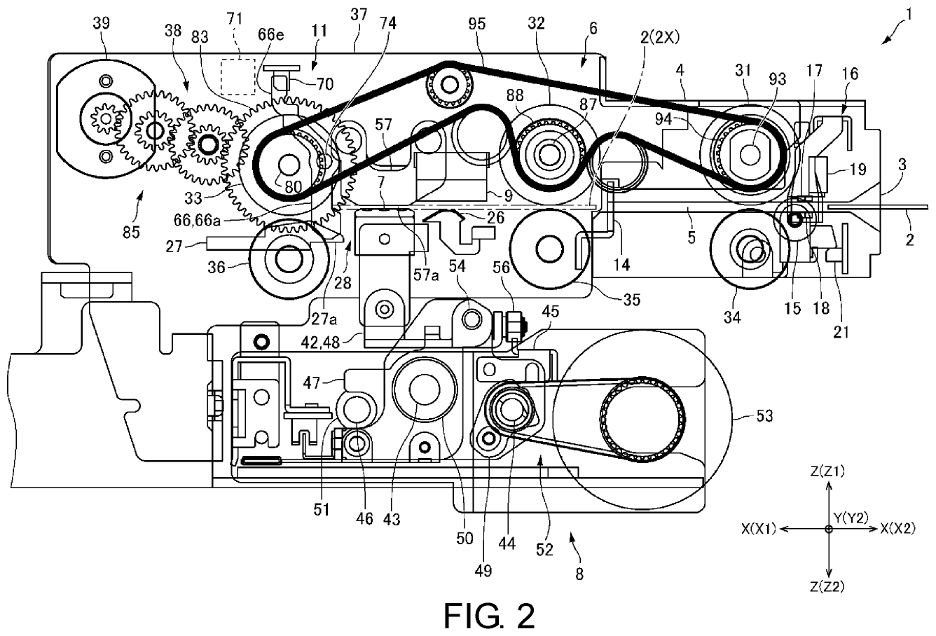

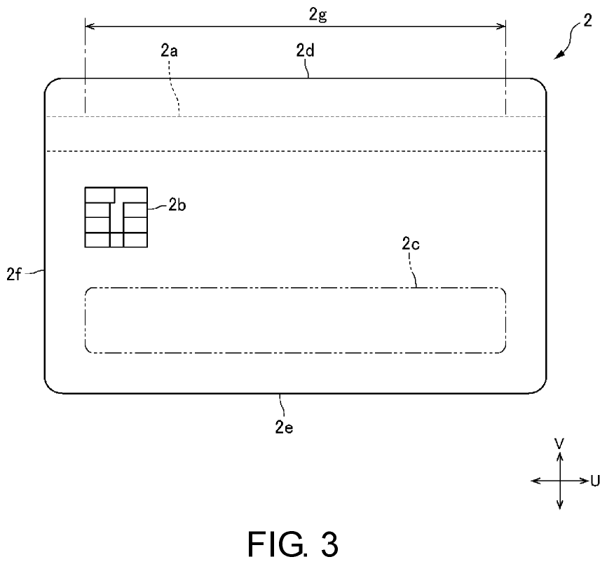

FIG. 1 is a perspective view of a card reader 1 according to an embodiment of the present invention. FIG. 2 is an explanatory view illustrating an internal configuration of the card reader 1 illustrated in FIG. 1 when viewed from a side. FIG. 3 is a plan view of a card 2 to be processed in the card reader illustrated in FIG. 1.

The card reader 1 is a device that performs at least one of reading of data recorded on the card 2 and writing of data on the card 2. The card reader 1 is used in a predetermined higher-level device, such as an automated teller machine (ATM). The card reader 1 includes a card insertion part 4. An insertion port 3 into which the card 2 is inserted is formed in the card insertion part 4. As illustrated in FIG. 2, a conveyance path 5 along which the card 2 is conveyed is formed inside the card reader 1. The conveyance path 5 is formed connecting to the insertion port 3.

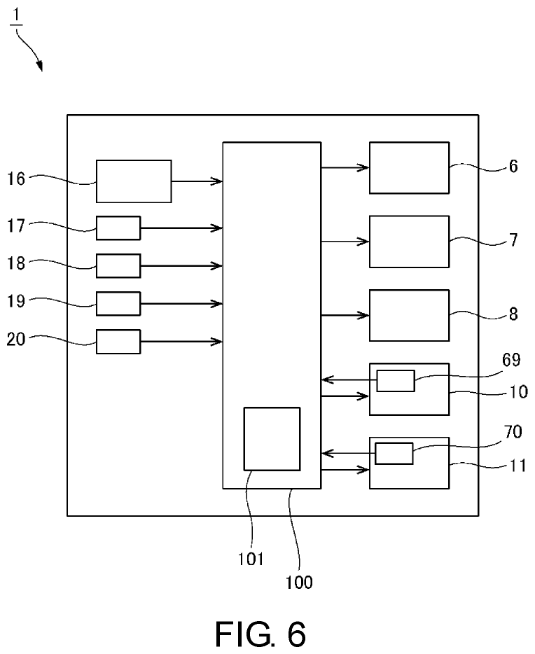

The card reader 1 also includes a card conveyance mechanism 6 that conveys the card 2, a magnetic head 7 that reads magnetic data recorded on the card 2 and writes magnetic data on the card 2 in contact with the card 2, a head moving mechanism 8 that moves the magnetic head 7 in a direction orthogonal to the conveyance direction of the card 2, an IC contact block 9 for communicating data in contact with a later-described terminal part 2b formed in the card 2, a contact block moving mechanism 10 (see FIG. 6) that moves the IC contact block 9 between a retracted position in which the IC contact block 9 is retracted from the conveyance path and a contact position in which the IC contact block 9 can communicate with the IC contact, and a positioning mechanism 11 for positioning the card 2 taken into the card reader 1.

The card 2 is made of vinyl chloride and has a thickness of about 0.7 mm to 0.8 mm. The card 2 of the present embodiment has a magnetic stripe and is embossed according to an international standard (for example, ISO/IEC 7811) or a JIS standard (for example, JIS X 6302). The card 2 is substantially rectangular in shape with rounded corners. A magnetic stripe 2a in which magnetic data is recorded is formed on a back surface of the card 2. The card 2 is a contact-type IC card. That is, the card 2 includes an IC chip (not illustrated) embedded therein, and a terminal part 2b formed by eight external connection terminals on a front surface thereof. A part of the card 2 is defined as an embossed area 2c to be embossed. Text, numbers, etc. (embossed portion) formed by embossing in the embossed area 2c protrude on a front surface side of the card 2.

The magnetic stripe 2a is formed in a long thin band shape parallel to the longitudinal direction of the card 2 (U direction in FIG. 3), and is formed in the entire area in the longitudinal direction U of the card 2. The magnetic stripe 2a is formed on a first end 2d side in the transverse direction (V direction in FIG. 3) of the card 2. More specifically, the magnetic stripe 2a is formed in a predetermined range with reference to the first end 2d of the card 2 in the transverse direction V of the card 2 based on an international standard or a JIS standard.

The terminal part 2b is formed at one end side in the longitudinal direction U of the card 2 and at a substantially intermediate position in the transverse direction V of the card 2. The eight external connection terminals forming the terminal part 2b are arranged in four columns in the transverse direction V of the card 2 and two rows in the longitudinal direction of the card 2. In addition, the eight external connection terminals are formed at predetermined positions with reference to the first end 2d of the card 2 in the transverse direction V of the card 2 and one end 2f of the card 2 in the longitudinal direction U based on an international standard or a JIS standard.

In the present embodiment, the card 2 is conveyed in the X direction illustrated in FIG. 1 and other drawings. More specifically, the card 2 is taken in the X1 direction and ejected in the X2 direction. That is, the X direction is the conveyance direction of the card 2, the X1 direction is the taking-in direction of the card 2, and the X2 direction is the ejecting direction of the card 2. Further, in the present embodiment, the card 2 is taken into the card reader 1 with the transverse direction V of the card 2 matching the X direction. The card 2 is conveyed inside the card reader 1 with the transverse direction V of the card 2 matching the X direction. The card reader 1 conveys the card 2 in the transverse direction V and performs predetermined processing.

The Y direction orthogonal to the X direction matches a width direction of the conveyance path 5, which is the longitudinal direction U of the card 2 taken into the card reader 1 in a correct position. The Z direction orthogonal to the X direction and the Y direction is a height direction of the conveyance path 5 and is a thickness direction of the card 2 taken into the card reader 1. In the present embodiment, the card reader 1 is disposed with the Z direction matching the up-down direction. In the following description, the X direction is “front-rear direction,” the Y direction as “left-right direction,” and the Z direction is “up-down direction,” the X1 direction side is a “back (rear)” side, the X2 direction side is a “front” side, the Y1 direction side is a “right” side, the Y2 direction side is a “left” side, the Z1 direction side is an “upper” side, and the Z2 direction side is a “lower” side.

(Card Insertion Part) The card insertion part 4 forms a front surface side portion of the card reader 1. The insertion port 3 opens on the front surface of the card insertion part 4 and extends in the left-right direction Y. The card insertion part 4 includes shutter members 14 and 15 disposed on the back side X1 of the insertion port 3, an insertion detection mechanism 16 detecting that the card 2 is inserted in the card reader 1 with the transverse direction V of the card 2 matching the front-rear direction X (that is, that the card 2 is inserted into the insertion port 3), magnetic sensors 17 and 18 detecting that magnetic data is recorded on the card 2, a metal sensor 19 detecting that the external connection terminals of the IC chip are fixed to the card 2 (that is, the terminal part 2b is fixed), and an infrared sensor 20 detecting a motion of a person in front of the card reader 1.

The shutter member 14 is disposed on the back end of the card insertion part 4. The shutter member 15 is disposed on the front side X2 relative to the shutter member 14. When the card 2 inserted from the insertion port 3 comes into contact with the shutter member 15, the shutter member 15 is moved to an open position. The card insertion part 4 also includes a sensor 21 detecting that the shutter member 15 is moved to the open position.

The insertion detection mechanism 16 is disposed at substantially the same position as the shutter member 15 in the front-rear direction X. The insertion detection mechanism 16 includes contact-type sensors each of which is disposed at each of left and right sides of the card insertion part 4. When the card 2 is inserted from the insertion port 3 with the transverse direction of the card 2 matching the front-rear direction X, a detection member of the sensor comes into contact with each of the two sensors. Therefore, based on detection results of the two sensors, it is detected that the card 2 is inserted from the insertion port 3 with the transverse direction V of the card 2 matching the front-rear direction X.

The magnetic sensors 17 and 18 are, for example, fluxgate sensors, and output a signal of a level corresponding to a distance from a magnetic material. The magnetic sensors 17 and 18 are arranged on both sides of the card 2 in the up-down direction Z inserted from the insertion port 3. When a level of a signal output from the magnetic sensor 17 is compared with a level of a signal output from the magnetic sensor 18, it is detected whether the card 2 is inserted from the insertion port 3 with the back surface facing the lower side Z2 or inserted from the insertion port 3 with the front surface facing the lower side Z2.

The metal sensor 19 is a magnetic sensor including an excitation coil, a detection coil, and a core around which the excitation coil and the detection coil are wound. The metal sensor 19 is disposed at a position through which the terminal part 2b of the card 2 inserted in a correct position passes in the left-right direction Y. In the present embodiment, based on detection results of the magnetic sensors 17 and 18 and a detection result of the metal sensor 19, it is detected that the card 2 is inserted from the first end 2d side of the card 2 or from a second end 2e side of the card 2.

The infrared sensor 20 is disposed on the front surface side of the card insertion part 4. The infrared sensor 20 is a pyroelectric infrared sensor and includes a pyroelectric element that detects light including infrared rays by a pyroelectric effect. The infrared sensor 20 detects a movement of a human hand or the like in front of the card reader 1. The infrared sensor 20 detects a motion of a person in front of the card reader 1 by detecting, for example, a difference between a temperature of the person in front of the card reader 1 and a temperature around the person within a detection range of the infrared sensor 20 based on the infrared ray generated by the person in front of the card reader 1.

(Conveyance Path and Card Conveyance Mechanism)

The conveyance path 5 is formed in substantially the entire area of the card reader 1 in the front-rear direction X. The card conveyance mechanism 6 includes conveyance rollers 31 to 33 that convey the card 2 in contact with an upper surface of the card 2 and pad rollers 34 to 36 arranged to face the conveyance rollers 31 to 33 from the lower side Z2. The conveyance rollers 31 to 33 are rubber rollers of which surfaces are formed of rubber. The pad rollers 34 to 36 are resin rollers of which surfaces are made of resin. The pad rollers 34 to 36 are urged toward the upper side Z1 and can be in contact with the card 2 from the lower side Z2. Note that the conveyance rollers 31 to 33 may be in contact with the lower surface of the card 2, and the pad rollers 34 to 36 may be arranged to face the conveyance rollers 31 to 33 from the upper side Z1.

The conveyance rollers 31 are disposed inside the card insertion part 4 and are disposed on the front side X2 relative to the shutter member 14. The conveyance rollers 32 and 33 are arranged inside a main body part 37 of the card reader 1. The card reader 1 is disposed on the back side X1 of the card insertion part 4. The conveyance rollers 32 are disposed on the front side X2 relative to the magnetic head 7 and the IC contact block 9 in the front-rear direction X, and are disposed on the back side X1 relative to the shutter member 14. Further, the conveyance rollers 33 are disposed on the back side X1 relative to the magnetic head 7, and are disposed on the back side X1 relative to a contact part 66a of a positioning member 66 which will be described later, that forms the positioning mechanism 11. First one of the conveyance rollers 31 to 33 and the pad rollers 34 to 36 are disposed at a left end of the conveyance path 5 and second one of the conveyance rollers 31 to 33 and the pad rollers 34 to 36 are disposed at a right end of the conveyance path 5. These rollers come in contact with both ends of the card 2 in the longitudinal direction U.

The conveyance rollers 33 are fixed to both ends of a rotating shaft 80 disposed with the left-right direction Y being a shaft direction. The conveyance rollers 32 are held at both ends of a rotating shaft 87 disposed with the left-right direction Y being the shaft direction via an unillustrated torque limiter. Further, the conveyance rollers 31 are fixed to a rotating shaft 93 disposed with the left-right direction Y being a shaft direction. As illustrated in FIG. 1, left end sides of the rotating shafts 80, 87, and 93 are rotatably held by a side plate 81 that forms a part of a left side surface of a frame of the main body part 37 of the card reader 1. Right end sides of the rotating shafts 80, 87, and 93 are rotatably held by a side plate 82 that forms a part of a right side surface of the frame of the main body part 37.

The left end sides of the rotating shafts 80, 87, and 93 protrude to the left side relative to the side plate 81, and a power transmission mechanism 38 formed by a belt, a pulley, a gear train, etc. is assembled to the protruding left end sides of the rotating shafts 80, 87, and 93. That is, a geared pulley 83 is fixed to a left end of the rotating shaft 80. As illustrated in FIG. 2, a motor 39 as a driving source is coupled to a gear of the geared pulley 83 via a gear train 85. A pulley 88 is fixed to a left end of the rotating shaft 87, and a pulley 94 is fixed to a right end side of the rotating shaft 93. A belt 95 is wound round the geared pulley 83 and the pulleys 88 and 94.

Guide members 26 and 27 that guide a lower surface of the card 2 are disposed inside the main body part 37. The guide member 26 is disposed between the conveyance roller 32, the pad roller 35 and the magnetic head 7 in the front-rear direction X, and is disposed on the lower side Z2 of the IC contact block 9. In the front-rear direction X, the guide member 27 is disposed on the back side X1 of the magnetic head 7, and is disposed at substantially the same position as the positioning mechanism 11.

In the present embodiment, each of the two guide members 26 is disposed at each of left and right end sides of the conveyance path 5. The guide member 27 includes two guide parts 27a arranged at predetermined intervals on the left and right. An upper surface of the guide member 26 and an upper surface of the guide part 27a form a part of the lower surface of the conveyance path 5. A space between the guide member 26 and the guide part 27a on the lower surface of the conveyance path 5 is an opening 28. The opening 28 is formed in substantially the entire area of the conveyance path 5 in the left-right direction Y.

(Positioning Mechanism) The positioning mechanism 11 includes the positioning member 66 in which the contact part 66a with which a back end of the card 2 taken into the card reader 1 comes into contact is formed, a solenoid 71 that drives the positioning member 66 via an unillustrated link member, and the like. The positioning mechanism 11 also includes a sensor 70 that detects a position of the positioning member 66, and a tension coil spring (not illustrated) that urges the positioning member 66. The positioning member 66 is rotatably held by a fixing shaft 74 of which shaft direction matches the left-right direction Y. A light shielding portion 66e that shields light in a space between a light emitting element and a light receiving element of the sensor 70 is formed at an upper end of the positioning member 66.

Normally, the positioning mechanism 11 is in a contact position in which a back end of the card 2 can be in contact with the contact part 66a, and in which rotation of the positioning member 66 around the fixing shaft 74 is inhibited. Therefore, when the card 2 is inserted from the insertion port 3 and is conveyed to the back side X1 by the card conveyance mechanism 6, the back end 2d of the card 2 comes into contact with the contact part 66a. Thus, the card 2 is positioned in the front-rear direction X. The positioning mechanism 11 positions the card 2 in a card processing position 2X in which reading and writing of magnetic data are performed by the magnetic head 7 and communication of IC data is performed by the IC contact block 9. When the back end of the card 2 is in contact with the contact part 66a, the light shielding portion 66e shields the light in the space between the light emitting element and the light receiving element of the sensor 70. Two sets of the positioning members 66 and the sensors 70 are provided, each of which pairs is arranged at each of both end sides of the conveyance path 5 in the left-right direction. It is detected that the card 2 is positioned in the card processing position 2X in the front-rear direction X based on detection results of the two sets of sensors 70.

The positioning member 66 is typically positioned in a contact position in which the back end of the card 2 can be in contact with the contact part 66a. When the solenoid 71 is driven, the contact part 66a is rotated in a direction to retract on the upper side Z1 of the conveyance path 5 via an unillustrated link member. When the contact part 66a retracts from the conveyance path 5 to the upper side Z1, the card 2 can pass toward the conveyance rollers 33 and the pad rollers 36.

(Magnetic Head and Head Moving Mechanism)

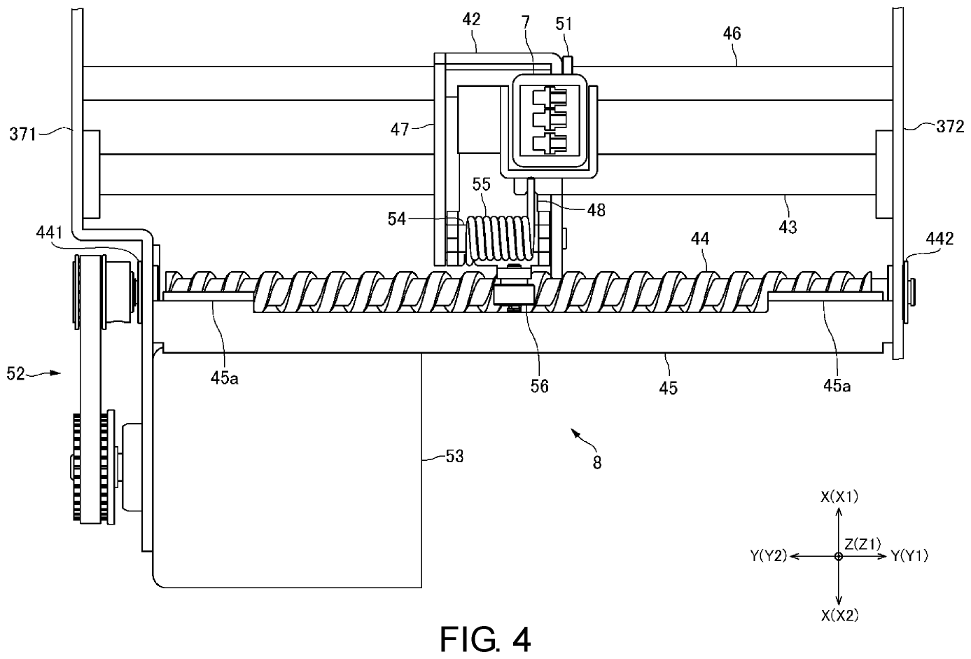

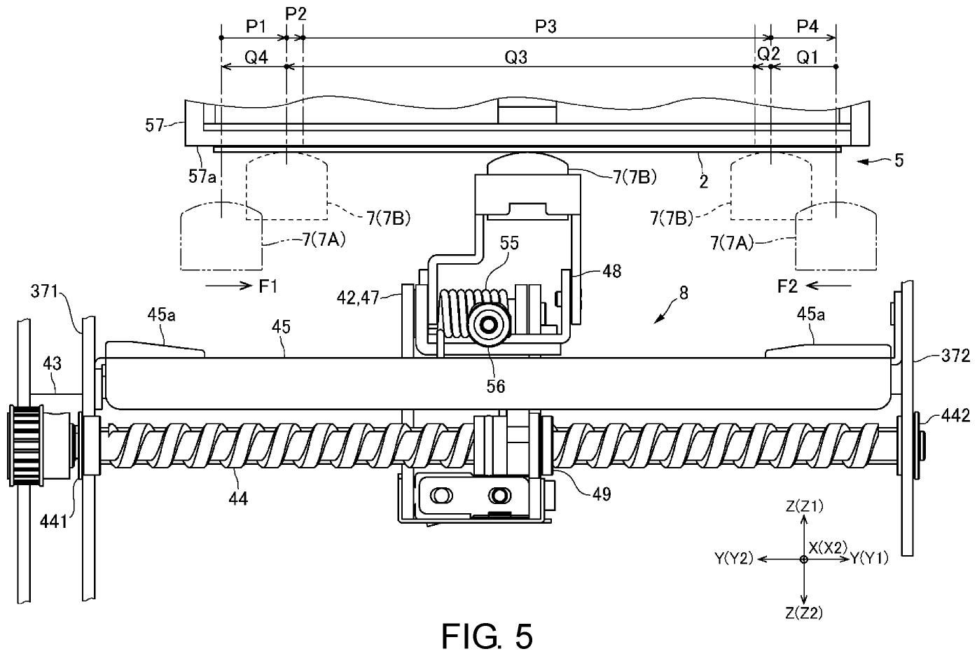

FIG. 4 is a plan view of the head moving mechanism 8. FIG. 5 is a front view of the head moving mechanism 8. As illustrated in FIG. 2, the magnetic head 7 is disposed between the conveyance rollers 32, the pad rollers 35, and the conveyance rollers 33, the pad rollers 36 in the front-rear direction X. As illustrated in FIGS. 4 and 5, the head moving mechanism 8 includes a carriage 42 in which the magnetic head 7 is mounted, a guide shaft 43 that guides the carriage 42 in the left-right direction Y, a lead screw 44 that feeds the carriage 42 in the left-right direction Y, a cam plate 45 that moves the magnetic head 7 in the up-down direction, and a rotation stopper shaft 46 that inhibits rotation of the carriage 42 around the guide shaft 43. The carriage 42 includes a carriage main body 47 and a head holding member 48 that holds the magnetic head 7. A female screw member 49 that engages the lead screw 44, a sliding bearing 50 (see FIG. 2) that engages the guide shaft 43, and a sliding member 51 that engages the rotation stopper shaft 46 are attached to the carriage main body 47. A motor 53 is coupled to the lead screw 44 via a power transmission mechanism 52 formed by a pulley and a belt.

The frame of the main body part 37 of the card reader 1 includes side plates 371 and 372 that form lower side parts of the left and right side surfaces of the main body part 37. As illustrated in FIGS. 4 and 5, the side plate 371 on the left side supports the motor 53 and the power transmission mechanism 52. Ends of the guide shaft 43 and ends of the rotation stopper shaft 46 are fixed to the side plates 371 and 372. A left end of the lead screw 44 is rotatably supported by a bearing member 441 attached to the side plate 371. A right end of the lead screw 44 is rotatably supported by a bearing member 442 attached to the side plate 372.

As illustrated in FIG. 4, a fixing shaft 54 that rotatably holds the head holding member 48 is fixed to the carriage main body 47 with the left-right direction Y being the shaft direction. A torsion coil spring 55 is disposed between the carriage main body 47 and the head holding member 48. The head holding member 48 is urged by urging force of the torsion coil spring 55 around the fixing shaft 54 in a direction to raise the magnetic head 7. The cam plate 45 is formed in an elongated shape in the left-right direction Y. A roller 56 is rotatably attached to the head holding member 48. The roller 56 comes into contact with cams 45a formed on both end sides of the cam plate 45 in the left-right direction Y.

In the present embodiment, when the motor 53 is driven to rotate the lead screw 44, the magnetic head 7 is moved in the left-right direction Y together with the carriage 42 along the guide shaft 43. When the carriage 42 is moved to both end sides in the left-right direction Y, the roller 56 comes into contact with the cam 45a. As illustrated by two-dot chain lines in FIG. 5, the magnetic head 7 is retracted to the lower side Z2 of the conveyance path 5 against the urging force of the torsion coil spring 55 when the roller 56 is in contact with the cam 45a. That is, when the carriage 42 is positioned at both ends of the lead screw 44 in the left-right direction Y, the magnetic head 7 moving in the left-right direction Y is positioned in the head retracted position 7A in which the magnetic head 7 is retracted from the conveyance path 5 to the lower side Z2.

When the carriage 42 is moved to a center side in the left-right direction Y and the roller 56 is disengaged from the cam 45a, the magnetic head 7 guided to retract from the conveyance path 5 to the lower side Z2 by the cam 45a is raised by the urging force of the torsion coil spring 55. The magnetic head 7 can be in contact with the magnetic stripe 2a of the card 2. That is, when the roller 56 is disengaged from the cam 45a, the magnetic head 7 is positioned in the head contact position 7B in which the magnetic head 7 can be in contact with the magnetic stripe 2a. When the carriage 42 is moved in the left-right direction Y while the magnetic head 7 is in contact with the magnetic stripe 2a, magnetic data is read and written by the magnetic head 7. When the magnetic head 7 is moved in the left-right direction Y, the magnetic head 7 passes through the opening 28.

In this manner, the head moving mechanism 8 moves the magnetic head 7 in the left-right direction Y, and moves the magnetic head 7 between the head contact position 7B in which the magnetic head 7 can be in contact with the magnetic stripe 2a and the head retracted position 7A in which the magnetic head 7 is retracted from the conveyance path 5. In a standby state before the card 2 is inserted in the card reader 1, the carriage 42 stands by at the left end of a movement range of the carriage 42. The left end of the movement range of the carriage 42 is the left end of the lead screw 44. A right end of the movement range of the carriage 42 is the right end of the lead screw 44. When the carriage 42 is positioned at the left end of the movement range, the magnetic head 7 is positioned in the head retracted position 7A in which the magnetic head 7 is retracted from the conveyance path 5 to the lower side Z2. That is, in the standby state before the card 2 is inserted in the card reader 1, the magnetic head 7 is positioned in the head retracted position 7A.

On the upper side Z1 of the magnetic head 7, an opposing member 57 is disposed. The opposing member 57 includes an opposing surface 57a that brings the magnetic head 7 positioned in the head contact position 7B into contact with the card 2 at predetermined contact pressure. The opposing surface 57a is a surface orthogonal to the up-down direction Z. A width of the opposing surface 57a in the left-right direction Y is substantially the same as the movement range of the magnetic head 7 in the left-right direction Y. When the magnetic head 7 is positioned in the head contact position 7B, the card 2 is disposed between the opposing surface 57a and the magnetic head 7 as illustrated in FIG. 5. At this time, the magnetic head 7 is brought into contact with the magnetic stripe 2a of the card 2 with predetermined contact pressure from below. The card 2 is inserted in a correct position.

(Schematic Operation of Card Reader)

In the card reader 1 configured as described above, the shutter member 14 is positioned in a closed position and closes the conveyance path 5 during standby before the card 2 is inserted from the insertion port 3. In this standby state, the magnetic head 7 is positioned in the head retracted position 7A in which the magnetic head 7 is retracted from the conveyance path 5, and the IC contact block 9 is positioned in the retracted position in which the IC contact block 9 is retracted from the conveyance path 5. Further, in this standby state, the contact part 66a of the positioning mechanism 11 is positioned in a position in which the contact part 66a can be into contact with the card 2 conveyed along the conveyance path 5.

The shutter member 14 disposed on the back side of the card insertion part 4 is moved to an open position when it is detected that a proper card 2 is inserted from the insertion port 3 in a correct position. That is, when it is detected based on a detection result of the sensor 21 that the card 2 is inserted from the insertion port 3, it is detected based on a detection result of the insertion detection mechanism 16 that the card 2 is inserted from the insertion port 3 such that the transverse direction V of the card 2 matches the front-rear direction X, and it is detected based on detection results of the magnetic sensors 17 and 18 and the metal sensor 19 that the card 2 provided with the terminal part 2b and having the magnetic data recorded therein is inserted from the first end 2d side of the card 2 with the back surface facing the lower side Z2, then the shutter member 14 is moved to the open position.

Further, when it is detected that a proper card 2 is inserted from the insertion port 3 in a correct position, the motor 39 is activated and the card conveyance mechanism 6 conveys the card 2 to the back side X1. When the first end 2d of the card 2 comes into contact with the contact part 66a of the positioning member 66 and the light going from the light emitting elements of the two sensors 70 to the light receiving elements is shielded by the light shielding portion 66e, it is detected that the card 2 is positioned in the card processing position 2X in the front-rear direction X. Then, the motor 39 is stopped. Further, in the card processing position 2X, since the card 2 is taken into the back side of the shutter member 14, the shutter member 14 is moved to the closed position and closes the conveyance path 5.

Thereafter, the head moving mechanism 8 and the magnetic head 7 are activated, and the magnetic head 7 is moved to the head contact position 7B in which the magnetic head 7 can be in contact with the magnetic stripe 2a. Then, the magnetic head 7 is moved in the left-right direction Y while being in contact with the magnetic stripe 2a of the card 2 to read and write the magnetic data. While reading or writing magnetic data by the magnetic head 7, the card 2 is held between the conveyance rollers 32 and the pad rollers 35 with the first end 2d thereof pressed against the contact part 66a.

(Control System)

FIG. 6 is a schematic block diagram illustrating the control system of the card reader 1. The card reader 1 includes a control unit 100 that controls, for example, the card conveyance mechanism 6, the magnetic head 7, the head moving mechanism 8, the contact block moving mechanism 10, and the positioning mechanism 11. The control unit 100 includes a storage unit 101 that stores a control program and various types of data. Detection signals of sensors provided in the card insertion part 4 (e.g., a sensor of the insertion detection mechanism 16, the magnetic sensors 17 and 18, the metal sensor 19, and the infrared sensor 20) are input in the control unit 100. A detection signal of the sensor 70 of the positioning mechanism 11, and a detection signal of a sensor 69 that detects a movement of the contact block moving mechanism 10 from a retracted position in which the contact block moving mechanism 10 is retracted from the conveyance path 5 to a contact position in which the contact block moving mechanism 10 can communicate with the IC contact are input in the control unit 100.

(Details of Operation of Magnetic Head)

The control unit 100 of the card reader 1 controls the magnetic head 7 and the head moving mechanism 8 to read the magnetic data recorded on the magnetic stripe 2a of the card 2 and write the magnetic data on the magnetic stripe 2a of the card 2. The control unit 100 controls the head moving mechanism 8 to perform a forward operation, which is a first scanning operation to move the carriage 42 in which the magnetic head 7 is mounted from the left end of the movement range to the right end of the movement range. In the forward operation, the magnetic head 7 reads the magnetic data. Further, the control unit 100 controls the head moving mechanism 8 to perform a backward operation, which is a second scanning operation to move the carriage 42 in which the magnetic head 7 is mounted from the right end of the movement range to the left end of the movement range. In the backward operation, the magnetic data is written by the magnetic head 7. Hereinafter, a scanning direction of the magnetic head 7 in the forward operation is referred to as a first direction F1 (see FIG. 5). A scanning direction of the magnetic head 7 in the backward operation is referred to as a second direction F2 (see FIG. 5). In the present embodiment, the first direction F1 is a direction toward the right side Y1 and the second direction F2 is a direction toward the left side Y2.

In the forward operation, a preparatory operation P1 to move the magnetic head 7 positioned in the head retracted position 7A on the left side to the head contact position 7B, a preliminary operation P2 to slightly move the magnetic head 7 in the first direction F1 in contact with the magnetic stripe 2a of the card 2, a reading operation P3 to read the magnetic data while moving the magnetic head 7 in the first direction F1 in contact with the magnetic stripe 2a of the card 2, and a retracting operation P4 to move the magnetic head 7 from the head contact position 7B to the head retracted position 7A on the right side are performed. FIG. 5 illustrates movement areas of the magnetic head 7 in each of the preparatory operation P1, the preliminary operation P2, the reading operation P3, and the retracting operation P4.

In the backward operation, a preparatory operation Q1 to move the magnetic head 7 positioned in the head retracted position 7A on the right side to the head contact position 7B, a preliminary operation Q2 to slightly move the magnetic head 7 in the second direction F2 in contact with the magnetic stripe 2a of the card 2, a writing operation Q3 to write the magnetic data while moving the magnetic head 7 in the second direction F2 in contact with the magnetic stripe 2a of the card 2, and a retracting operation Q4 to move the magnetic head 7 from the head contact position 7B to the head retracted position 7A on the left side are performed. FIG. 5 illustrates movement areas of the magnetic head 7 in each of the preparatory operation Q1, the preliminary operation Q2, the writing operation Q3, and the retracting operation Q4.

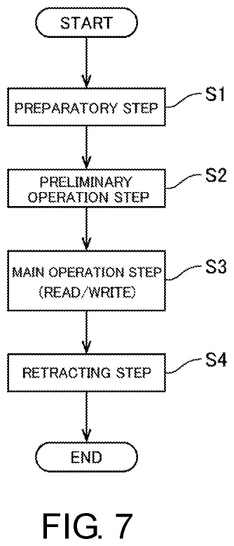

FIG. 7 is a flowchart illustrating control of the magnetic head 7 and the head moving mechanism 8. As described above, the control unit 100 of the card reader 1 performs an operation of conveying the card 2 inserted into the insertion port 3 in the transverse direction V and positioning the card 2 in the card processing position 2X (taking-in step). When the card 2 is positioned in the card processing position 2X, processing of steps S11 to S14 is performed. In step S1 (preparatory step), a preparatory operation P1 to move the magnetic head 7 from the head retracted position 7A on the left side to the left end of the head contact position 7B is performed. More specifically, the motor 53 is activated to move the carriage 42 in the first direction F1 until the roller 56 is disengaged from the cam 45a. Thus, the magnetic head 7 meets a position near the left end of the magnetic stripe 2a of the card 2.

Next, the control unit of the card reader 1 performs steps S2 and S3 based on a magnetic data reading command. First, in step S2 (preliminary operation step), the preliminary operation P2 to move the carriage 42 and the magnetic head 7 by a predetermined amount in the first direction F1 with the magnetic head 7 being in contact with the magnetic stripe 2a is performed. The movement amount of the carriage 42 and the magnetic head 7 in the preliminary operation P2 is set to a slight movement amount of, for example, about 1 mm. In the present embodiment, the movement amount of the carriage 42 and the magnetic head 7 in the preliminary operation P2 is controlled based on the number of pulses of the encoder provided in the head moving mechanism 8. When a stepping motor is used as the motor 53, a rotation amount of the motor can be controlled in step S2 based on the number of driving steps of the motor 53. In step S2, the motor 53 is rotated at a constant speed to move the carriage 42 and the magnetic head 7 at a constant speed. Note that the moving speed of the carriage 42 and the magnetic head 7 in step S2 is lower than the moving speed (target speed) of the magnetic head 7 when magnetic data is read or written in step S3 described later.

Subsequently, in step S3 (main operation step), the reading operation P3 of the magnetic data is performed. In step S3, the carriage 42 and the magnetic head 7 are moved in the same movement direction as in step S2 (first direction F1), and magnetic data is read by the magnetic head 7. At this time, control is performed to first cause the moving speed of the carriage 42 and the magnetic head 7 to reach a predetermined target speed and, thereafter, the magnetic data is read by the magnetic head 7 while the carriage 42 and the magnetic head 7 are moved at the target speed (at a constant speed). Although the magnetic stripe 2a extends to the edges of the card 2 as illustrated in FIG. 3, a data recording area 2g of the magnetic stripe 2a is separated from the ends of the magnetic stripe 2a by a predetermined dimension. In step S3, control is performed to cause the moving speed of the magnetic head 7 to reach the target speed within the movement range until the magnetic head 7 reaches the end of the data recording area 2g.

In step S3, after the reading operation P3 of the magnetic data is performed, a reading result of the magnetic data is transmitted to the outside. Thereafter, the process proceeds to step S4, and a retracting operation P4 is performed to move the magnetic head 7 from the head contact position 7B to the head retracted position 7A on the right. That is, the carriage 42 is moved in the first direction F1, the roller 56 is brought into contact with the cam 45a on the right side, and the magnetic head 7 is moved to the head retracted position 7A.

The backward operation is performed in the same manner as the forward operation, except that the moving direction of the carriage 42 and the magnetic head 7 is opposite to that of the forward operation and that writing of the magnetic data is performed instead of reading of the magnetic data. That is, in the backward operation, the preparatory operation Q1 to move the magnetic head 7 positioned in the head retracted position 7A on the right side to the right end of the head contact position 7B is performed in step S1 (preparatory step). Next, in step S2 (preliminary operation step), the preliminary operation Q2 to slightly move the magnetic head 7 in the second direction F2 in contact with the magnetic stripe 2a of the card 2 is performed. Subsequently, the writing operation Q3 to write the magnetic data while moving the magnetic head 7 in the second direction F2 in contact with the magnetic stripe 2a of the card 2 is performed in step S3 (main operation step). Then, the retracting operation Q4 to move the magnetic head 7 from the left end of the head contact position 7B to the head retracted position 7A on the left side is performed in step S4 (retracting step).

(Main Effects of Present Embodiment)

As described above, the card reader 1 according to the present embodiment moves the magnetic head 7 for scanning in the left-right direction Y to read the magnetic data recorded on the card 2 and write the magnetic data. More specifically, the card reader 1 performs the reading operation of reading the magnetic data by scanning the magnetic data in the first direction F1 and the writing operation of writing the magnetic data by scanning the magnetic data in the second direction F2. Prior to these reading operation and writing operation (main operation step), the preliminary operation step to move the magnetic head 7 by a predetermined amount (e.g., about 1 mm) in the same scanning direction as each of these operations is performed.

By performing such a preliminary operation step, even if a backlash caused by wearing due to use, gaps present for reasons of design, or the like increases and an unloaded area increases, a phenomenon that the head moving mechanism 8 operates unloaded during the preliminary operation can be eliminated. Therefore, a reading operation or a writing operation can be started under normal driving load. Therefore, there is little possibility that the moving speed of the magnetic head 7 does not reach the target speed before the magnetic head 7 reaches the data recording area 2g on the magnetic stripe 2a due to an increase in a change in the speed in the unloaded area. Therefore, lowering in reading accuracy and writing accuracy caused by an increase in gaps between parts can be inhibited. Therefore, the life of the product can be prolonged. Further, to reliably reach the target speed, it is not necessary to increase the head movement distance (approach distance) before reaching the data recording area 2g. Therefore, this configuration is advantageous for downsizing of the card reader in the head scanning direction (that is, the left-right direction Y).

In particular, in the present embodiment, since the preliminary operation step is performed in both the reading operation and the writing operation, the magnetic data can be properly processed in both the reading operation and the writing operation. Therefore, lowering in reading accuracy and writing accuracy can be inhibited. Since it is not necessary to increase the approach distance in the first direction and in the second direction, this configuration is advantageous for downsizing of the card reader 1 in the head scanning direction.

In the present embodiment, the taking-in step of conveying the substantially rectangular card 2 in the transverse direction V thereof and positioning the card 2 in the card processing position 2X is performed. The scanning direction of the magnetic head 7 during reading and writing of the magnetic data is the direction orthogonal to the conveyance direction (X direction) of the card 2. In this way, when the card 2 is conveyed in the transverse direction V, the head scanning direction matches a width direction of the card reader. Thus, it is necessary to increase the scanning space in the card reader in the width direction in order to increase the approach distance, which may upsize the card reader 1 in the width direction. In the present embodiment, however, the target speed can be reached with a short approach distance by performing the preliminary operation step, and it is not necessary to increase the scanning space in the card reader in the width direction. Therefore, this configuration is advantageous for downsizing of the card reader 1.

In the present embodiment, the magnetic head 7 can be moved to the head retracted position 7A in which the magnetic head 7 is not in contact with the card 2 and the head contact position 7B in which the magnetic head 7 is in contact with the card, and the preparatory step of moving the magnetic head 7 to the head retracted position 7A to the head contact position 7B is performed before the preliminary operation step is started. The preliminary operation step and the main operation step (reading operation and writing operation) are performed with the magnetic head 7 moved to the head contact position 7B. Therefore, there is little possibility that the conveyance of the card 2 is hindered by the magnetic head 7 when positioning the card 2 in a position in which the processing by the magnetic head 7 is performed.

In the present embodiment, the motor 53 that moves the magnetic head 7 is rotated at a constant speed in the preparatory operation step. Therefore, there is little possibility that the movement speed of the magnetic head 7 will fluctuate significantly in the preliminary operation step.

### Other Embodiments

The embodiment described above is one example of a preferred embodiment of the present invention, but the invention is not limited to this. Various modified embodiments are possible without departing from the spirit and scope of the present invention.

(1) In the embodiment described above, the magnetic data is read while the magnetic head 7 is moved for scanning to one side (first direction F1) in the left-right direction Y, the magnetic data is written while the magnetic head 7 is moved to the other side (second direction F2) in the left-right direction Y, and the preliminary operation is performed prior to both the reading operation and the writing operation of the magnetic data. However, the preliminary operation may be performed for one of the reading operation and the writing operation. For example, the preliminary operation may be performed for the writing operation performed in the backward operation. In the forward operation of moving the magnetic head 7 for scanning from the standby position in the first direction F, it is also possible to reliably reach the target speed of the magnetic head 7 by extending the approach distance within the range of the existing scanning space. However, it is difficult to increase the approach distance in the backward operation, and an increase in the approach distance may cause an upsize of the card reader 1 in the left-right direction Y. Therefore, by performing the preliminary operation immediately before the writing operation performed in the backward operation, upsizing of the card reader 1 can be avoided and lowering in writing accuracy can be inhibited. Further, the present invention is applicable to a card reader that performs one of a reading operation and a writing operation.

(2) In the embodiment described above, the magnetic data is read during the forward operation of the magnetic head 7 (the first scanning operation in which the magnetic head 7 is moved in the first direction F1), magnetic data is written during the backward operation (the second scanning operation in which the magnetic head 7 is moved in the second direction F2), and the preliminary operation is performed prior to both or one of these operations. However, when magnetic data is read in the backward operation and magnetic data is written in the forward operation, the preliminary operation may be performed prior to both or one of these operations. Further, reading and writing of magnetic data may be performed not in a single reciprocating operation of the magnetic head 7 but in two reciprocating operations. For example, magnetic data may be read in a first forward operation, magnetic data may be written in a second forward operation, and magnetic data may be read in the backward operation to check written contents. Even in this case, the preliminary operation can be performed prior to both or one of the forward operation (first scanning operation) and the backward operation (second scanning operation). If magnetic data is written in the forward operation, recording start positions of the magnetic data can be aligned. More specifically, distances from the end of the magnetic stripe 2a (that is, the edge of the card 2) to the recording start positions of the magnetic data can become the same. Thus, it is possible to avoid that the recording start positions of the magnetic data becomes different from a position defined by a standard.

### DESCRIPTION OF REFERENCE NUMERALS

1: Card reader
2: Card
2a: Magnetic stripe
2b: Terminal part
2c: Embossed area
2d: First end in transverse direction of card
2e: Second end in transverse direction of card
2f: One end in longitudinal direction of card
2g: Data recording area
2X: Card processing position
3: Insertion port
4: Card insertion part
5: Conveyance path
6: Card conveyance mechanism
7: Magnetic head
7A: Head retracted position
7B: Head contact position
8: Head moving mechanism
9: IC contact block
10: Contact block moving mechanism
11: Positioning mechanism
14, 15: Shutter members
16: Insertion detection mechanism
17, 18: Magnetic sensors
19: Metal sensor
20: Infrared sensor
21: Sensor
26, 27: Guide members
27a: Guide part
28: Opening
31, 32, 33: Conveyance rollers
34, 35, 36: Pad rollers
37: Main body part
38: Power transmission mechanism
39: Motor
42: Carriage
43: Guide shaft
44: Lead screw
45: Cam plate
45a: Cam
46: Rotation stopper shaft
47: Carriage main body
48: Head holding member
49: Female screw member
50: Sliding bearing
51: Sliding member
52: Power transmission mechanism
53: Motor
54: Fixing shaft
55: Torsion coil spring
56: Conveyance roller
57: Opposing member
57a: Opposing surface
66: Positioning member
66a: Contact part
66e: Light shielding part
69: Sensor
70: Sensor
71: Solenoid
74: Fixing shaft
80: Rotating shaft
81, 82: Side plates
83: Pulley
85: Gear train
87: Rotating shaft
88: Pulley
93: Rotating shaft
94: Pulley
95: Belt
100: Control unit
101: Storage unit
371, 372: Side plates
441, 442: Bearing members
F1: First direction
F2: Second direction
P1: Preparatory operation
P2: Preliminary operation
P3: Reading operation
P4: Retracting operation
Q1: Preparatory operation
Q2: Preliminary operation
Q3: Writing operation
Q4: Retracting operation
U: Longitudinal direction of card
V: Transverse direction of card
X: Front-rear direction (card conveyance direction)
X1: Back side
X2: Front side
Y: Left-right direction (scanning direction by magnetic head)
Y1: Right side
Y2: Left side
Z: Up-down direction
Z1: Upper side
Z2: Lower side

1. A method for controlling a card reader that performs at least one of processings of reading magnetic data recorded on a card and writing magnetic data on the card by scanning with a magnetic head, the method comprising:
performing a preliminary operation step of moving the magnetic head by a predetermined amount in a scanning direction in performing the processing, prior to a main operation step of performing the processing by scanning with the magnetic head.

2. The method for controlling a card reader according to claim 1, wherein
a taking-in step of conveying a substantially rectangular card in a transverse direction of the card and positioning the card in a predetermined position in which the processing is to be performed by the magnetic head is performed; and
the scanning direction of the magnetic head is a direction orthogonal to a conveyance direction of the card.

3. The method for controlling a card reader according to claim 2, wherein
in the main operation step, prior to a first scanning operation of moving the magnetic head for scanning in a first direction, the preliminary operation step of moving the magnetic head by a predetermined amount in the first direction is performed; and
in the main operation step, prior to a second scanning operation of moving the magnetic head for scanning in a second direction opposite to the first direction, the preliminary operation step of moving the magnetic head by a predetermined amount in the second direction is performed.

4. The method for controlling a card reader according to claim 3, wherein
the magnetic head is movable to a head retracted position in which the magnetic head does not come into contact with the card and a head contact position in which the magnetic head comes into contact with the card;
a preparatory step of moving the magnetic head from the head retracted position to the head contact position is performed before the preliminary operation step is started; and
the preliminary operation step and the main operation step are performed with the magnetic head moved to the head contact position.

5. The method for controlling a card reader according to claim 4, wherein
in the preliminary operation step, a motor that moves the magnetic head is rotated at a constant speed.

6. The method for controlling a card reader according to claim 3, wherein
in the preliminary operation step, a motor that moves the magnetic head is rotated at a constant speed.

7. The method for controlling a card reader according to claim 2, wherein
the magnetic head is movable to a head retracted position in which the magnetic head does not come into contact with the card and a head contact position in which the magnetic head comes into contact with the card;
a preparatory step of moving the magnetic head from the head retracted position to the head contact position is performed before the preliminary operation step is started; and
the preliminary operation step and the main operation step are performed with the magnetic head moved to the head contact position.

8. The method for controlling a card reader according to claim 7, wherein
in the preliminary operation step, a motor that moves the magnetic head is rotated at a constant speed.

9. The method for controlling a card reader according to claim 2, wherein
in the preliminary operation step, a motor that moves the magnetic head is rotated at a constant speed.

10. The method for controlling a card reader according to claim 1, wherein
in the main operation step, prior to a first scanning operation of moving the magnetic head for scanning in a first direction, the preliminary operation step of moving the magnetic head by a predetermined amount in the first direction is performed; and
in the main operation step, prior to a second scanning operation of moving the magnetic head for scanning in a second direction opposite to the first direction, the preliminary operation step of moving the magnetic head by a predetermined amount in the second direction is performed.

11. The method for controlling a card reader according to claim 10, wherein
the magnetic head is movable to a head retracted position in which the magnetic head does not come into contact with the card and a head contact position in which the magnetic head comes into contact with the card;
a preparatory step of moving the magnetic head from the head retracted position to the head contact position is performed before the preliminary operation step is started; and
the preliminary operation step and the main operation step are performed with the magnetic head moved to the head contact position.

12. The method for controlling a card reader according to claim 11, wherein
in the preliminary operation step, a motor that moves the magnetic head is rotated at a constant speed.

13. The method for controlling a card reader according to claim 10, wherein
in the preliminary operation step, a motor that moves the magnetic head is rotated at a constant speed.

14. The method for controlling a card reader according to claim 1, wherein
the magnetic head is movable to a head retracted position in which the magnetic head does not come into contact with the card and a head contact position in which the magnetic head comes into contact with the card;
a preparatory step of moving the magnetic head from the head retracted position to the head contact position is performed before the preliminary operation step is started; and
the preliminary operation step and the main operation step are performed with the magnetic head moved to the head contact position.

15. The method for controlling a card reader according to claim 14, wherein
in the preliminary operation step, a motor that moves the magnetic head is rotated at a constant speed.

16. The method for controlling a card reader according to claim 1, wherein
in the preliminary operation step, a motor that moves the magnetic head is rotated at a constant speed.
